(19) United States
(12) Patent Application Publication
(10) Pub. No.: US 2026/0037886 A1
(43) Pub. Date: Feb. 5, 2026

(54) SYSTEMS AND METHODS FOR GENERATING A STAFFING PLAN

(71) Applicant: JPMORGAN CHASE BANK, N.A., New York, NY (US)

(72) Inventors: Rudolph L. MAPPUS, IV, Plano, TX (US); Siva TANUKU, Westerville, OH (US); Sai Chaitanya DARLA, McKinney, TX (US); Owen CHURCHILL, Columbus, OH (US)

(21) Appl. No.: 18/193,100

(22) Filed: Mar. 30, 2023

(51) Int. Cl. G06Q 10/0631; H04M 3/51

(52) U.S. Cl. CPC G06Q 10/06311; G06Q 10/06315; H04M 3/5175; H04M 2203/402

(57) ABSTRACT

In some aspects, the techniques described herein relate to a method including: predicting, with a machine learning model, a predicted contact volume and a predicted contact duration of customer contacts with a contact center for a future time period; providing input data to a planning application, wherein the input data includes the predicted contact volume, the predicted contact duration, a number of available staff members and a number of available contact time units of each of the number of available staff members; and computing, by the planning application, a staffing plan, wherein the staffing plan minimizes a difference between a total number of predicted customer contact time units and a total number of staff member contact time units for the future time period.

### BACKGROUND

### 1. Field of the Invention

Aspects generally relate to systems and methods for generating a staffing plan.

### 2. Description of the Related Art

Understanding volume for incoming customer-initiated contacts at a firm's contact center (e.g., a help desk or call center) is an essential function for capacity planners and operations functions in servicing and help desk management. Being able to estimate the number and duration of requests gives capacity planners a volume forecast that can be used to adjust staffing levels, train current staff for skills, and to assign queues to staff for servicing. Accurately predicting and precisely applying such information, however, continues to be a challenge, particularly at the enterprise level.

### SUMMARY

In some aspects, the techniques described herein relate to a method for generating a staffing plan, including: predicting, using a machine learning model, a predicted contact volume and a predicted contact duration of customer contacts with a contact center for a future time period; providing input data to a planning application, wherein the input data includes the predicted contact volume, the predicted contact duration, a number of available staff members and a number of available contact time units of each of the number of available staff members; and computing, by the planning application, a staffing plan, wherein the staffing plan minimizes a difference between a total number of predicted customer contact time units and a total number of staff member contact time units for the future time period.

In some aspects, the techniques described herein relate to a method, including: training the machine learning model with observed historical contact data.

In some aspects, the techniques described herein relate to a method, wherein the total number of predicted customer contact time units and the total number of staff member contact time units are measured in minutes.

In some aspects, the techniques described herein relate to a method, including: computing a staffing plan for each future time period of an extended time horizon.

In some aspects, the techniques described herein relate to a method, wherein the extended time horizon is 90 days.

In some aspects, the techniques described herein relate to a method, wherein the future time period is an hour.

In some aspects, the techniques described herein relate to a method, wherein each future time period of the extended time horizon is an hour.

In some aspects, the techniques described herein relate to a system for generating a staffing plan including at least one computer including a processor, wherein the at least one computer is configured to: predict, using a machine learning model, a predicted contact volume and a predicted contact duration of customer contacts with a contact center for a future time period; provide input data to a planning application, wherein the input data includes the predicted contact volume, the predicted contact duration, a number of available staff members and a number of available contact time units of each of the number of available staff members; and compute, by the planning application, a staffing plan, wherein the staffing plan minimizes a difference between a total number of predicted customer contact time units and a total number of staff member contact time units for the future time period.

In some aspects, the techniques described herein relate to a system, wherein the at least one computer is configured to: train the machine learning model with observed historical contact data. 10 The system, wherein the total number of predicted customer contact time units and the total number of staff member contact time units are measured in minutes.

In some aspects, the techniques described herein relate to a system, wherein the at least one computer is configured to: compute a staffing plan for each future time period of an extended time horizon.

In some aspects, the techniques described herein relate to a system, wherein the extended time horizon is 90 days.

In some aspects, the techniques described herein relate to a system, wherein the future time period is an hour.

In some aspects, the techniques described herein relate to a system, wherein each future time period of the extended time horizon is an hour.

In some aspects, the techniques described herein relate to a non-transitory computer readable storage medium, including instructions stored thereon for generating a staffing plan, which instructions, when read and executed by one or more computer processors, cause the one or more computer processors to perform steps including: predicting, using a machine learning model, a predicted contact volume and a predicted contact duration of customer contacts with a contact center for a future time period; providing input data to a planning application, wherein the input data includes the predicted contact volume, the predicted contact duration, a number of available staff members and a number of available contact time units of each of the number of available staff members; and computing, by the planning application, a staffing plan, wherein the staffing plan minimizes a difference between a total number of predicted customer contact time units and a total number of staff member contact time units for the future time period.

In some aspects, the techniques described herein relate to a non-transitory computer readable storage medium, including: training the machine learning model with observed historical contact data.

In some aspects, the techniques described herein relate to a non-transitory computer readable storage medium, wherein the total number of predicted customer contact time units and the total number of staff member contact time units are measured in minutes.

In some aspects, the techniques described herein relate to a non-transitory computer readable storage medium, including: computing a staffing plan for each future time period of an extended time horizon.

In some aspects, the techniques described herein relate to a non-transitory computer readable storage medium, wherein the extended time horizon is 90 days.

In some aspects, the techniques described herein relate to a non-transitory computer readable storage medium, wherein the future time period is an hour, and wherein each future time period of the extended time horizon is an hour.

### BRIEF DESCRIPTION OF THE DRAWINGS

FIG. 1 is a block diagram of a system for generating a staffing plan, in accordance with aspects.

FIG. 2 is a logical flow of a system for generating a staffing plan, in accordance with aspects.

FIG. 3 is a block diagram of a computing device for implementing certain aspects of the present disclosure.

### DETAILED DESCRIPTION

Aspects generally relate to systems and methods for generating a staffing plan.

In accordance with aspects, techniques described herein may predict incoming contact volumes serviced by product-specific queues, predicting incoming contact durations for customer contacts such telephone calls with an organization's contact center. Aspects may provide optimized staffing parameters given the predicted volume and duration of contacts.

In accordance with aspects telephone calls (sometimes referred to as “calls” herein) to an organization's contact center are used to illustrate techniques described in more detail herein. It is contemplated, however, that the describe techniques may be applied to various forms of customer contacts. Exemplary contact types may include phone calls, video calls, text-based messages such as instant messages, emails, etc.

Aspects may provide predictions of volume and duration of contacts and provide improved volume predictions at various time intervals (e.g., hour intervals). Predictions may be used to produce staffing plans at designated time horizons. Such estimates may be generated for call queues to allow planners at each time horizon window to minimize absolute differences between capacity and contact volume and to allow for different time horizon actions to influence such differences.

In accordance with aspects, time horizon windows may include various time frames (e.g., 90-day, 30-day, 7-day, 1-day, etc.) where predictions may be employed for planning specific actions with respect to workforce requirements (e.g., hiring plans, training plans, scheduling, and day-of assignments). Aspects may allow users to specify actions for corresponding time horizon windows, and system outputs may provide staffing plans to minimize the difference in capacity and predicted volume.

In accordance with aspects, input data may include an organization's staff details such as individuals who may be assigned to contact queues (such as incoming call queues), and an amount of time that the individuals will be assigned to one or more queues. Individuals available for queue assignment may be sorted based on contact skills/ability and training to handle various contact types and contact queues. Contact types/queues may include phone calls, text-based messages such as instant messages, emails, etc.

Planning users may specify a planning horizon window's planning cadence needed to produce a corresponding staffing plan for the planning horizon window. Staffing plans may include staffing actions that can be taken and the date and times to initiate the staffing plans in the corresponding time horizon window that actions plans are mapped to. A planning cadence may indicate the regularity with which staffing plans are generated and released. Aspects may use these inputs to schedule and generate staffing plans at a contact center level or at a contact queue level.

In accordance with aspects, proposed techniques may predict the number of contacts to a support desk at each hour of a day. Providing hour-level estimates of volumes may allow planning users at a short horizon window (e.g., hourly) to assign available capacity to contact queues. Techniques may also provide planning users planning for longer horizon windows to take actions based on predicted volumes.

Aspects may utilize machine learning (ML) techniques, including machine learning algorithms and models, to generate predictions. The proposed techniques may utilize a combination of regression ML algorithms employing a suite of features derived using time series algorithms to produce corresponding models to predict the number of customer requests that will arrive. For instance, Gradient Boosted Machines, Random Forests, and Support Vector Machine regression methods may be used to produce ML model estimators for contact volumes. The outputs of various regression algorithms may be averaged to produce estimates of volume over a time period (e.g., hourly).

Additionally, various sets of ML models may be generated which reflect different time periods. For example, one model may be generated for weekday (i.e., Monday-Friday) patterns and one model for weekend (e.g., Saturday and Sunday) patterns. Other exemplary models may be generated to predict volume over other time periods (e.g., time periods that include one or more holidays, time periods based on seasons, etc.) Trained models may be executed and process current observations as input to produce predictions for planning users and staffing plans. As predictions are generated, the outputs may be used as inputs in generating further predictions. Estimates may be generated in this fashion for any planning time horizons (i.e., predictions are generated and used as input for subsequent predictions until all time horizons are covered. Aspects may be designed to minimize the mean absolute percentage error between estimates and actuals.

Table 1 includes descriptions of data that may be used as training data input for ML algorithms, in accordance with aspects. The data described in Table 1 may be used to train ML algorithms to generate ML models for prediction of customer contact/call volume over a given time horizon. Table 1 includes a “Data Name” column, a “Data Type” column and a “Description” column. The Data Name column provides an exemplary name/reference for a storage field in a datastore. A data name may be used, e.g., as a reference to query a value of a data field having the corresponding data name. The Data Type column describes the type of data that values in a corresponding filed may receive/store. The Description column provides a description of the data value in a corresponding field. Some of the data in Table 1 may be persisted as observed and other data may be computed from persisted data (e.g., the moving average data). While the table references a customer call type and call queues, it is contemplated that similar data may be collected and similarly used for any type of customer contact. The data in Table 1 is exemplary and other data, as necessary or desired, may be used in training contact volume models.

In accordance with aspects, a call volume variable is the target variable for predictions from models trained on the data included in, or similar to that of, Table 1. That is, a desired output prediction for a given time period of a contact volume model is predicted volume, which may be based on observed volume.

TABLE 1

| Data Name | Data Type | Description |
|---|---|---|
| Call_queue | String | Queue identifier |
| Call_type | String | Type of call received |
| Date | Date | Date time (hourly) |
| Count_prev_week_same_hour | Number | Volume at the same |
| | | time last week |
| Count_2_prev_week_same_hour | Number | Volume at the same |
| | | time 2 week lag |
| Count_3_prev_week_same_hour | Number | Volume at the same |
| | | time 3 week lag |
| Count_4_prev_week_same_hour | Number | Volume at the same |
| | | time 4 week lag |
| Count_5_prev_week_same_hour | Number | Volume at the same |
| | | time 5 week lag |
| Count_6_prev_week_same_hour | Number | Volume at the same |
| | | time 6 week lag |
| Count_7_prev_week_same_hour | Number | Volume at the same |
| | | time 7 week lag |
| Count_8_prev_week_same_hour | Number | Volume at the same |
| | | time 8 week lag |
| Ma_3h | Number | Moving average |
| | | last 3 hours |
| Ma_6h | Number | Moving average |
| | | last 6 hours |
| Ma_12h | Number | Moving average last 12 |
| | | hours |
| Ma_18h | Number | Moving average last 18 |
| | | hours |
| Ma_24h | Number | Moving average last 24 |
| | | hours |
| Ma_1w | Number | Moving average last |
| | | week |
| Holiday_avg | Number | Avg for previous holiday |
| | | one for each (Christmas, |
| | | Columbus Day, |
| | | Independence Day, |
| | | Juneteenth, |
| | | Labor Day, Martin |
| | | Luther King Day, |
| | | Memorial Day, |
| | | New Year's day, |
| | | Thanksgiving, |
| | | Veteran's day, |
| | | Presidents' day, etc.) |
| Holiday_upper | Number | Highest volume calls for |
| | | holiday one for each |
| | | (Christmas, Columbus |
| | | Day, Independence Day, |
| | | Juneteenth, Labor Day, |
| | | Martin Luther King Day, |
| | | Memorial Day, |
| | | New Year's day, |
| | | Thanksgiving, |
| | | Veterans' day, |
| | | Presidents' day, etc.) |
| Holiday_lower | Number | Lowest volume |
| | | calls for holiday |
| | | one for each |
| | | (Christmas, Columbus |
| | | Day, Independence |
| | | Day, Juneteenth, |
| | | Labor Day, Martin |
| | | Luther King Day, |
| | | Memorial Day, |
| | | New Year's day, |
| | | Thanksgiving, |
| | | Veterans' day, |
| | | Presidents' day, etc.) |
| Obs_volume | Number | Observed call volume |
| | | for date time |

Aspects may also predict a duration of a defined type of contact. Each call type may represent a separate regression case. Aspects may further use a suite of regression methods for each contact type case, which suite may be similar as described above for volume prediction. With respect to call duration predictions based on call type, a ML model may be generated for a particular contact queue and/or contact type. The regression algorithms for duration may use historical call duration input/training data for the same hourly time ranges as for call volumes. Techniques may minimize the mean absolute percentage error between estimates and actuals.

Table 2 includes descriptions of data that may be used as contact duration training data input for ML algorithms, in accordance with aspects. The data described in Table 2 may be used to train ML algorithms to generate ML models for prediction of customer contact duration for a given defined contact/call type. Table 2 includes a “Data Name” column, a “Data Type” column and a “Description” column. The Data Name column provides an exemplary name/reference for a storage field in a datastore. A data name may be used, e.g., as a reference to query a value of a data field having the corresponding data name. The Data Type column describes the type of data that values in a corresponding filed may receive/store. The Description column provides a description of the data value in a corresponding field. While the table references customer call types and call queues, it is contemplated that similar data may be collected and similarly used for any type of customer contact. The data in Table 1 is exemplary and other data, as necessary or desired, may be used in training contact volume models.

TABLE 2

| Data Name | Data Type | Description |
|---|---|---|
| Call_queue | String | Queue identifier |
| Date | Date | Date |
| Call_type | String | Call type label |
| Count_prev_week_same_hour | Number | Duration for this call |
| | | type at the same time |
| | | last week |
| Count_2_prev_week_same_hour | Number | Duration for this call |
| | | type at the same time |
| | | 2 week lag |
| Count_3_prev_week_same_hour | Number | Duration for this call type |
| | | at the same time 3 week |
| | | lag |
| Count_4_prev_week_same_hour | Number | Duration for this call type |
| | | at the same time 4 week |
| | | lag |
| Count_5_prev_week_same_hour | Number | Duration for this call type |
| | | at the same time 5 week |
| | | lag |
| Count_6_prev_week_same_hour | Number | Duration for this call type |
| | | at the same time 6 week |
| | | lag |
| Count_7_prev_week_same_hour | Number | Duration for this call type |
| | | at the same time 7 week |
| | | lag |
| Count_8_prev_week_same_hour | Number | Duration for this call type |
| | | at the same time 8 week |
| | | lag |
| Ma_3h | Number | Moving average duration |
| | | last 3 hours |
| Ma_6h | Number | Moving average duration |
| | | last 6 hours |
| Ma_12h | Number | Moving average duration |
| | | last 12 hours |
| Ma_18h | Number | Moving average duration |
| | | last 18 hours |
| Ma_24h | Number | Moving average duration |
| | | last 24 hours |
| Ma_1w | Number | Moving average duration |
| | | last week |
| Holiday_avg | Number | Avg duration for previous |
| | | holiday one for each |
| | | (Christmas, Columbus |
| | | Day, Independence Day, |
| | | Juneteenth, Labor Day, |
| | | Martin Luther King Day, |
| | | Memorial Day, |
| | | New Year's day, |
| | | Thanksgiving, |
| | | Veterans' day, Presidents' |
| | | day, etc.) |
| Holiday_upper | Number | Highest duration calls for |
| | | holiday one for each |
| | | (Christmas, Columbus |
| | | Day, Independence Day, |
| | | Juneteenth, Labor Day, |
| | | Martin Luther King Day, |
| | | Memorial Day, |
| | | New Year's day, |
| | | Thanksgiving, |
| | | Veterans' day, Presidents' |
| | | day, etc.) |
| Holiday_lower | Number | Lowest duration calls for |
| | | holiday one for each |
| | | (Christmas, Columbus |
| | | Day, Independence Day, |
| | | Juneteenth, Labor Day, |
| | | Martin Luther King Day, |
| | | Memorial Day, |
| | | New Year's day, |
| | | Thanksgiving, |
| | | Veterans' day, Presidents' |
| | | day, etc.) |

In accordance with aspects, various models may provide daily predicts of both volumes and durations of customer contacts with an organization's contact center. Moreover, daily predictions may predict forward over a specified time period, such as 30 or 90 days, such that planning users and planning systems receive a fresh forward-looking window for the specified time period on a daily basis. Prediction models may further be configured to provide predictions for sub-timeframes within a longer time horizon. For a given time horizon, models may produce hour-by-hour predictions of both contact volume and contact duration.

Aspects may provide staffing plans to capacity planning users that minimize the difference between the volume and the capacity for each call queue at each hour of a day. To accomplish this, aspects may use a mixed integer linear programming solver for the objective function. For instance, aspects may compute staffing plans for use by capacity planning users that minimize the difference between the volume and the capacity for each call queue for each hour of a day. To accomplish this, aspects may use a mixed integer linear programming solver for the objective function. For instance, aspects may compute

$$arg {min}_{p , m} \frac{Σ \vert ξ - λ \vert}{n} ,$$

where ξ=vd and λ=pm.

In accordance with aspects and with respect to the equation above, the variable v may be an estimated volume of a call type for a horizon window (e.g., an hour), and the variable d may be the estimated duration of the call types in the corresponding horizon window (e.g., for the same hour). Further, p may be a binary valued vector indicating if a staff member is available (i.e., is a particular staff member working at the hour the volume and duration predictions are made for?) and m may represent the number of expected contact-time minutes the corresponding staff member is able to dedicate to customer contacts in the relevant hour.

Accordingly, the constraints may be given as Σp<P and Σm<S, Where P represents the limit of the number of staff individuals scheduled, and S represents the sum of the expected minutes for the staffs' working time block (independent of staff selections). A solution to this optimization computation may be used to formulate a staffing plan for use with a time horizon window under consideration.

The output of the optimization is a staffing plan for assigning individuals to work the evaluated time windows that minimizes the difference between the expected volume and the estimated capacity. Aspects may generate a staffing plan for aligning staff to the assigned plan based on the described computations. For each individual assigned in the staffing plan, the actions are identified by their state. For example, if the assigned individual is leaving the firm, a hiring action may be taken. If the assigned individual does not have the skills to work the evaluated queue, training may be assigned to the individual. Schedules or call center staff may also or additionally be derived from the staffing plan.

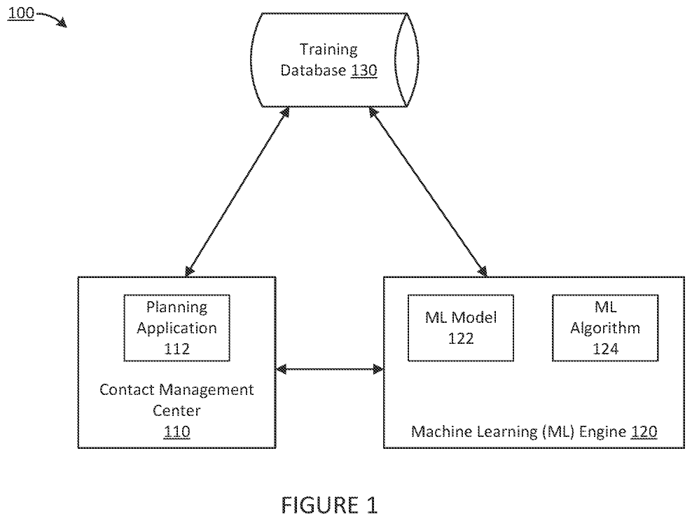

FIG. 1 is a block diagram of a system for generating a staffing plan, in accordance with aspects. System 100 includes contact management center 110, which executes planning application 112. System 100 further includes machine learning (ML) engine 120, which executes ML model 122 and ML algorithm 124. System 100 additionally includes training database 130.

In accordance with aspects, contact management center 110 may include the technology backend of a contact center of an organization. Contact management center 110 may include hardware and software required to operate a customer contact center, such as telephone systems, instant messaging systems, recording systems, call routing systems including voice over internet protocol (VoIP) routers and servers, contact queue management hardware and software, etc. Additionally, contact management center 110 may include planning application 112, which may execute on servers in contact management center 110. In other aspects, planning application 112 may be remote (i.e., executed on remote servers in, e.g., a remote data center), but in operative communication with contact management center 110.

Contact management center 110 may include hardware and software to monitor and record details with respect to incoming customer contacts, such as contact volume over a given period and a duration of individual contacts. Contact management center 110 may be in operative communication with training database 130. Other details with respect to incoming customer contacts may also be recorded, as is necessary or desired. Contact management center 110 may be configured to persistently store contact details in training database 130. Contact details may be associated with the date and/or time at which they were received/recorded and be stored as historic contact data.

In accordance with aspects, ML engine 120 may also be in operative communication with training database 130. ML engine 120 may be configured to retrieve historic contact data from training database 130. ML engine 120 may further be configured to derive additional information from the stored contact information. For instance, ML engine 120 may be configured to compute moving average data for time periods, with respect to both contact volume and contact duration. ML engine 120 may be further configured to process retrieved and computed data with ML algorithm 124. ML algorithm 124 may process the contact detail data and may fit ML model 122 to the processed data. While ML engine 120 is shown executing only ML model 122 and ML algorithm 124, it is contemplated that ML engine 120 may execute several ML algorithms that train several corresponding models, as described in more detail, herein. Moreover, ML engine 120 may include various models for predicting contact volume and contact duration.

In accordance with aspects, ML model 122 may be configured to receive inputs and make predictions based on the inputs. For instance, ML model 122 may be configured to receive a future time period as an input and generate a prediction of contact volume as an output. In other aspects, ML model 122 may receive a future time period as an input and generate a prediction of contact duration for the time period. ML engine 120 may be in operative communication with planning application 112 and may be configured to send generated predictions (e.g., of contact volume and contact duration) to planning application 112 for additional processing.

In accordance with aspects, planning application 112 may be configured to receive generated predictions from ML model 122 and use the generated predictions to compute a staffing plan. A computed staffing plan may minimize the difference between a total number of predicted contact time units (e.g., minutes, hours, etc.) and the time unit capacity of call center staff. Staffing plans may be computed for the entire call center and/or for each contact queue and for each hour of a future time period.

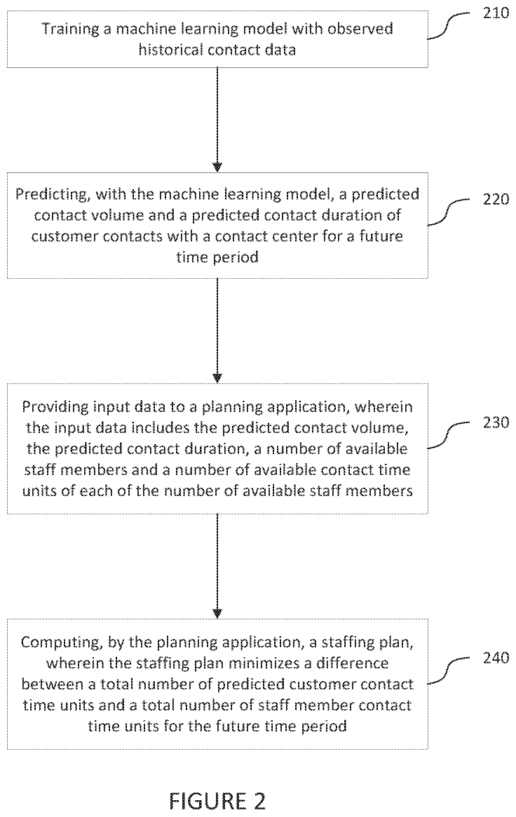

FIG. 2 is a logical flow of a system for generating a staffing plan, in accordance with aspects.

Step 210 includes training a machine learning model with observed historical contact data.

Step 220 includes predicting, with a machine learning model, a predicted contact volume and a predicted contact duration of customer contacts with a contact center for a future time period.

Step 230 includes providing input data to a planning application, wherein the input data includes the predicted contact volume, the predicted contact duration, a number of available staff members and a number of available contact time units of each of the number of available staff members.

Step 240 includes computing, by the planning application, a staffing plan, wherein the staffing plan minimizes a difference between a total number of predicted customer contact time units and a total number of staff member contact time units for the future time period.

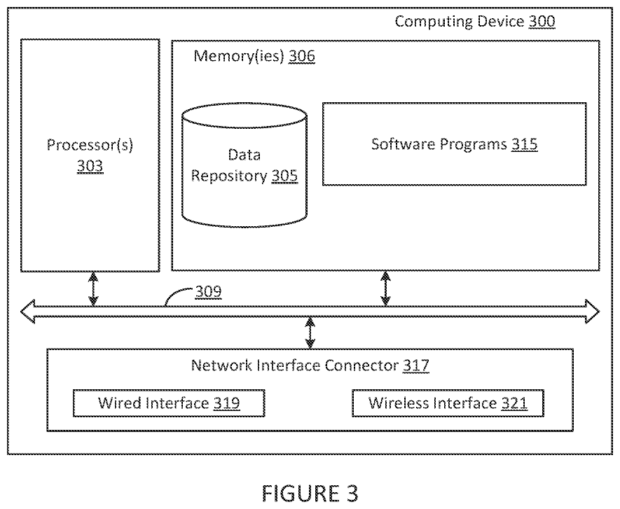

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a contact management center, a ML engine, a planning application, various database engines and database servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, a computer application, a program, a software program, or simply as software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method for generating a staffing plan, comprising:
receiving, by a computing system comprising at least one processor and memory, observed historical contact data from a plurality of disparate data sources, the observed historical contact data comprising a data name, a call type, a description, and moving average data, wherein the observed historical contact data is pre-processed to normalize time intervals and remove outliers;
training a regression machine learning model with observed historical contact data comprising a data name, a call type, a description, and moving average data;
predicting, using the regression machine learning model, a predicted contact volume and a predicted contact duration of customer contacts with a contact center for a future time period;
automatically detecting anomalous patterns in the predicted contact volume and predicted contact duration using a statistical anomaly detection module, and adjusting the predictions based on detected anomalies;
providing input data to a planning application, wherein the input data includes the predicted contact volume of the call type for the future time period, the predicted contact duration of the call type for the future time period, a number of available staff members and a number of available contact time units of each of the number of available staff members; and
computing, by the planning application, a staffing plan,
wherein the staffing plan minimizes a difference between a total number of predicted customer contact time units and a total number of staff member contact time units for the future time period by finding argmin_{p,m}Σ|vd−pm|, wherein the variable v is the predicted contact volume of the call type for the future time, wherein the variable d is the predicted contact duration of the call type for the future time period, wherein the variable p is a binary valued vector indicating if a staff member of the number of available staff members is available,
wherein the value m is the number of available contact time units the staff member is available for in the future time period,
wherein the total number of predicted customer contact time units and the total number of staff member contact time units are measured in minutes,
wherein the planning application executes on a distributed computing environment and dynamically updates the staffing plan in real-time in response to changes in predicted contact volume or staff availability, and wherein the method provides, as output, a machine-generated staffing plan that is not practically feasible to generate manually or with conventional rule-based systems.

2. (canceled)

3. (canceled)

4. The method of claim 1, comprising:
computing a staffing plan for each future time period of an extended time horizon.

5. The method of claim 4, wherein the extended time horizon is 90 days.

6. The method of claim 5, wherein the future time period is an hour.

7. The method of claim 6, wherein each future time period of the extended time horizon is an hour.

8. A system for generating a staffing plan comprising at least one computer including a processor, wherein the at least one computer is configured to:
receive and store in a memory of the at least one computer an observed historical contact data from a plurality of disparate data sources, the observed historical contact data comprising a data name, a call type, a description, and moving average data, wherein the observed historical contact data is pre-processed to normalize time intervals and remove outliers;
train a regression machine learning model with observed historical contact data comprising a data name, a call type, a description, and moving average data;
predicting, using the regression machine learning model, a predicted contact volume and a predicted contact duration of customer contacts with a contact center for a future time period;
automatically detect anomalous patterns in the predicted contact volume and predicted contact duration using a statistical anomaly detection module, and adjusting the predictions based on detected anomalies;
provide input data to a planning application, wherein the input data includes the predicted contact volume, the predicted contact duration, a number of available staff members and a number of available contact time units of each of the number of available staff members; and
compute, by the planning application, a staffing plan,
wherein the staffing plan minimizes a difference between a total number of predicted customer contact time units and a total number of staff member contact time units for the future time period by finding argmin_{p,m}Σ|vd−pm|, wherein the variable v is the predicted contact volume of the call type for the future time, wherein the variable d is the predicted contact duration of the call type for the future time period,
wherein the variable p is a binary valued vector indicating if a staff member of the number of available staff members is available, wherein the value m is the number of available contact time units the staff member is available for in the future time period,
wherein the total number of predicted customer contact time units and the total number of staff member contact time units are measured in minutes,
wherein the planning application executes on a distributed computing environment and dynamically updates the staffing plan in real-time in response to changes in predicted contact volume or staff availability, and wherein the method provides, as output, a machine-generated staffing plan that is not practically feasible to generate manually or with conventional rule-based systems.

9. (canceled)

10. (canceled)

11. The system of claim 8, wherein the at least one computer is configured to:
compute a staffing plan for each future time period of an extended time horizon.

12. The system of claim 11, wherein the extended time horizon is 90 days.

13. The system of claim 12, wherein the future time period is an hour.

14. The system of claim 13, wherein each future time period of the extended time horizon is an hour.

15. A non-transitory computer readable storage medium, including instructions stored thereon for generating a staffing plan, which instructions, when read and executed by one or more computer processors, cause the one or more computer processors to perform steps comprising:
receiving, by a computing system comprising at least one processor and memory, observed historical contact data from a plurality of disparate data sources, the observed historical contact data comprising a data name, a call type, a description, and moving average data, wherein the observed historical contact data is pre-processed to normalize time intervals and remove outliers;
training a regression machine learning model with observed historical contact data comprising a data name, a call type, a description, and moving average data;
predicting, using the regression machine learning model, a predicted contact volume and a predicted contact duration of customer contacts with a contact center for a future time period;
automatically detecting anomalous patterns in the predicted contact volume and predicted contact duration using a statistical anomaly detection module, and adjusting the predictions based on detected anomalies;
providing input data to a planning application, wherein the input data includes the predicted contact volume, the predicted contact duration, a number of available staff members and a number of available contact time units of each of the number of available staff members; and
computing, by the planning application, a staffing plan,
wherein the staffing plan minimizes a difference between a total number of predicted customer contact time units and a total number of staff member contact time units for the future time period by finding argmin_{p,m}Σ|vd−pm|,
wherein the variable v is the predicted contact volume of the call type for the future time,
wherein the variable d is the predicted contact duration of the call type for the future time period, wherein the variable p is a binary valued vector indicating if a staff member of the number of available staff members is available,
wherein the value m is the number of available contact time units the staff member is available for in the future time period,
wherein the total number of predicted customer contact time units and the total number of staff member contact time units are measured in minutes,
wherein the planning application executes on a distributed computing environment and dynamically updates the staffing plan in real-time in response to changes in predicted contact volume or staff availability, and wherein the method provides, as output, a machine-generated staffing plan that is not practically feasible to generate manually or with conventional rule-based systems.

16. (canceled)

17. (canceled)

18. The non-transitory computer readable storage medium of claim 15, comprising:
computing a staffing plan for each future time period of an extended time horizon.

19. The non-transitory computer readable storage medium of claim 18, wherein the extended time horizon is 90 days.

20. The non-transitory computer readable storage medium of claim 19, wherein the future time period is an hour, and wherein each future time period of the extended time horizon is an hour.
